(19) United States
(12) Patent Application Publication
(10) Pub. No.: US 2010/0142595 A1
(43) Pub. Date: Jun. 10, 2010

(54) METHOD OF TRANSMITTING AND RECEIVING SIGNAL IN COMMUNICATION SYSTEM

(75) Inventors: Mun-Geon Kyeong, Daejeon (KR); Woo-Goo Park, Seoul (KR); In-Cheol Jeong, Seoul (KR); Jae-Sang Cha, Seoul (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/517,175

(22) PCT Filed: Nov. 30, 2007
(86) PCT No.: PCT/KR07/06141

§ 371 Date: Feb. 5, 2010

(30) Foreign Application Priority Data
Dec. 1, 2006 (KR) 10-2006-0120647
May 2, 2007 (KR) 10-2007-0042510

(51) Int. Cl. H04B 1/707

(52) U.S. Cl. 375/148; 375/146; 375/E01.032

(57) ABSTRACT

A communication system generates a continuously orthogonal spreading code for a user, a user signal is spreading-modulated by using the continuously orthogonal spreading codes, and then the spread signal is pre-rake combined and transmitted. A receiver processes the received signal by using a matched filter for one path.

### BACKGROUND OF THE INVENTION

(a) Field of the Invention

The present invention relates to a signal transmitting and receiving method of a communication system. More particularly, the present invention relates to a signal transmitting and receiving method using a pre-rake method.

(b) Description of the Related Art

When a conventional pre-rake transmission method is applied to a base station of the code division multiplexing (CDM)/code division multiple access (CDMA) system using time division duplexing (TDD), a terminal can acquire the same diversity effect as that of a rake receiver without any additional diversity synthesis circuit.

Since the pre-rake transmission method transmits signals of multiple paths compared to the general CDM/CDMA method that transmits the signals through a single path, the pre-rake transmission method is greatly influenced by multi-path interference (MPI) or multiple access interference (MAI) that the wireless communication system originally has. Therefore, when the pre-rake transmission method is applied to the communication system, the bit error rate (BER) of the communication system is substantially degraded and the data reception efficiency is worsened.

It is required to additionally apply an interference canceller to the communication system so as to reduce the interference, but there is no efficient interference cancellation technique, and it is difficult to realize this interference cancellation technique. It increases hardwired burdens, and hence the advantage of the pre-rake transmission method used for simplifying the terminal is lost.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a signal transmitting and receiving method of a communication system having advantages of reducing the interference that occurs when the pre-rake transmission method is used.

In one aspect of the present invention, a method for transmitting a signal through a multipath channel in a communication system includes generating a continuously orthogonal spreading code for a user, generating a spreading-modulated signal for a user signal by using the continuously orthogonal spreading code, and performing a pre-rake combining on the spread signal and transmitting the pre-rake combined signal.

A channel impulse response for the multipath channel may be combined with the spread signal to perform the pre-rake combining.

The continuously orthogonal spreading code may be continuously orthogonal for a predetermined time interval or it has an autocorrelation value and a cross-correlation value as 0 for a predetermined time interval.

The continuously orthogonal spreading code may include one of a zero correlation duration (ZCD) code, a zero correlation zone (ZCZ) code, and a large area synchronous (LAS) code.

In another aspect of the present invention, a method for receiving a signal through a multipath channel in a communication system includes receiving a pre-rake combined transmission signal through the multipath channel, and processing the received signal by using a matched filter for one path.

In another aspect of the present invention, a method for transmitting a signal through a multipath channel in a communication system includes spreading modulation for a user signal by a spreading code having a continuously orthogonal characteristic for a predetermined time interval, combining a channel impulse response for the multipath channel and the spreading-modulated signal, and transmitting the channel impulse response combined spread signal.

### BRIEF DESCRIPTION OF THE DRAWINGS

FIG. 1 shows a block diagram of a communication system according to an exemplary embodiment of the present invention.

FIG. 2 is a block diagram of a transmitter of a communication system shown in FIG. 1.

FIG. 3 shows a flowchart of a method for a transmitter according to an exemplary embodiment of the present invention to generate a transmission signal.

FIG. 4 shows an autocorrelation characteristic and a cross-correlation characteristic of a binary ZCD spread code.

FIG. 5 shows bit error rate performance of the CDM/CDMA wireless communication system in which the pre-rake method is applied to the Walsh-Hadamard spreading code with 32 chips in the Rayleigh fading condition having three paths and the multiple access condition.

FIG. 6 shows bit error rate performance of the CDM/CDMA wireless communication system in which the pre-rake method is applied to the continuously orthogonal spreading code with 32 chips in the Rayleigh fading condition having three paths and the multiple access condition.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims which follow, unless explicitly described to the contrary, the word “comprising” or variations such as “comprises” will be understood to imply the inclusion of stated elements but not the exclusion of any other elements. Also, each block in the present specification represents a unit for processing at least one function or operation, which can be realized by hardware, software, or combination of hardware and software.

A signal transmitting method and receiving method of a communication system according to an exemplary embodiment of the present invention will now be described with reference to the drawings.

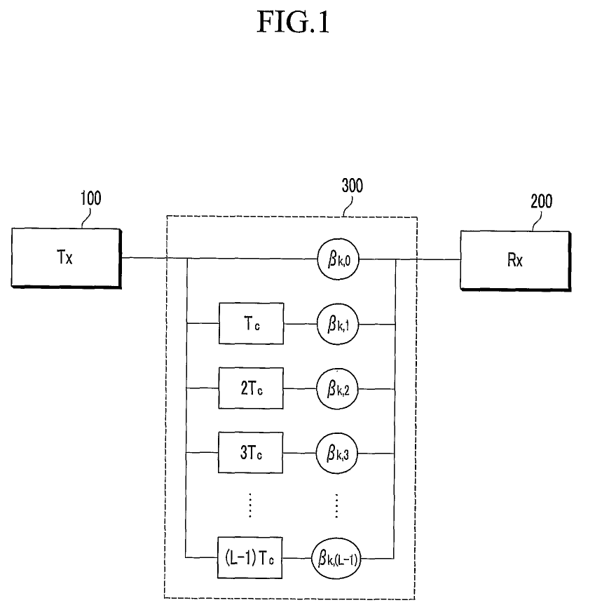

FIG. 1 shows a block diagram of a communication system according to an exemplary embodiment of the present invention.

As shown in FIG. 1, the communication system includes a transmitter 100 and a receiver 200 connected through a multipath channel 300. The transmitter 100 can be formed in a base station, and it spreading-modulates an input signal, performs a pre-rake combining process on the spreading-modulated signal, and outputs a resultant signal. The receiver 200 can be formed in a terminal, and it receives the signal from the transmitter 100 through the multipath channel 300 and restores the received signal.

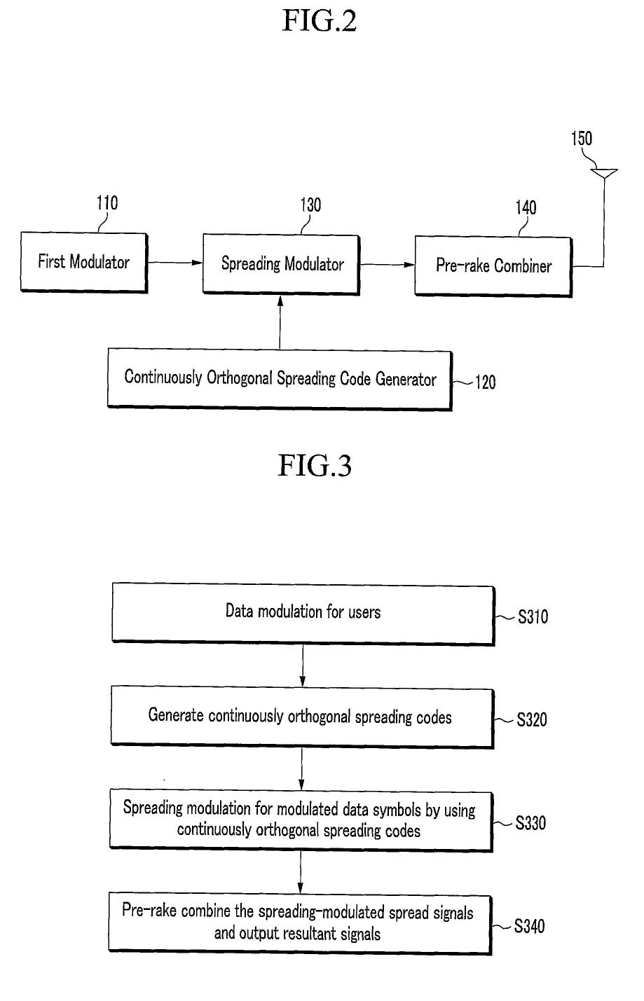

The transmitter 100 and a method for the transmitter 100 to perform a pre-rake combining on the input signal and output a resultant signal will now be described with reference to FIG. 2 and FIG. 3.

FIG. 2 is a block diagram of a transmitter 100, and FIG. 3 shows a flowchart of a method for the transmitter 100 to generate a transmission signal.

As shown in FIG. 2, the transmitter 100 includes a first modulator 110, a continuously orthogonal spreading code generator 120, a spreading modulator 130, a pre-rake combiner 140 and a transmit antenna 150.

Referring to FIG. 3, the first modulator 110 modulates data for a predetermined user (S310) by using various digital modulation methods including phase shift keying (PSK) modulation, quadrature phase shift keying (QPSK) modulation, and quadrature amplitude modulation (QAM). The continuously orthogonal spreading code generator 120 generates a spreading code that has a continuously orthogonal characteristic for a predetermined time (hereinafter, a continuously orthogonal spreading code) (S320), and the spreading modulator 130 spreading-modulates the data symbol value modulated by the first modulator 110 by using the continuously orthogonal spreading code (S330). The pre-rake combiner 140 converts the spreading-modulated transmission signal into a pre-rake combined signal and outputs the resultant signal through the transmit antenna 150 (S340).

In detail, the spread modulator 130 of the transmitter 100 spread-modulates the input signal modulated by the first modulator 110, and the pre-rake combiner 140 performs a pre-rake combining on the spreading modulated signal, and outputs a transmission signal that is expressed in Equation 1.

$$\frac{1}{U} {\sum }_{l = 0}^{L - 1} {β}_{l}^{*} {s}_{s} ( t - {lT}_{c} ) \qquad ( Equation 1 )$$

where sₛ(t) is a spread signal that is generated by the spreading-modulation for the input signal by the spreading modulator 130, βₗ is a value found by time inverting a channel impulse response, and β*ₗ is the conjugated complex of βₗ. U is a normalizing factor, is used to control power of the pre-rake combined output signal to be constant, and is expressed as Equation 2.

$$U = {( {\sum }_{l = 0}^{L - 1} {β}_{l} {β}_{l}^{*} )}^{\frac{1}{2}} \qquad ( Equation 2 )$$

In a like manner of Equation 1, the spread signal sₛ(t) is combined with the channel impulse response that is time inverted by the pre-rake combiner 140, and a channel impulse response hₖ(t) of the multipath channel 300 shown in FIG. 1 can be expressed as Equation 3.

$${h}_{k} ( t ) = {\sum }_{l = 0}^{L - 1} {β}_{k , l} exp ( {jγ}_{k , l} ) δ ( t - {lT}_{c} ) \qquad ( Equation 3 )$$

where L is the number of channel paths, β_{k,l} is a path gain and is an independent identically distributed (i.i.d.) Rayleigh random variable for all k's and l's, γ_{k,l} represents a phase and is uniformly distributed in [0,π), T_{c} is a one-chip interval of the spreading code, and E[β_{k,l}] is assumed to be 1.

In the case of the time division duplex (TDD) system, it can be assumed that the channel impulse response hₖ(t) between the continuous uplink time slot and the downlink time slot is constant in the condition with less channel variation. The base station receives the signals from the terminals during the uplink time interval by using the rake receiver to estimate the channel impulse response hₖ(t) for the user k.

The transmitted signal of Equation 1 that is received as a received signal by the receiver 200 through the multipath channel 300 is expressed in Equation 4.

$$\frac{1}{U} {\sum }_{j = 0}^{L - 1} {\sum }_{l = 0}^{L - 1} {β}_{l}^{*} {β}_{l - 1 - j} {s}_{s} ( t - ( l + j ) {T}_{c} ) \qquad ( Equation 4 )$$

where the received signal has 2L−1 paths according to Equation 4.

Also, an output value of a matched filter of the receiver 200 satisfying the path corresponding to the time of t=(L−1)T_{c} is expressed in Equation 5.

$$\frac{G}{{U}^{2}} {( {\sum }_{l = 0}^{L - 1} {β}_{l} {β}_{l}^{*} )}^{2} \qquad ( Equation 5 )$$

where G is a process gain.

When the continuously orthogonal spreading code for the user k and the channel impulse response of Equation 3 are used in the CDM/CDMA communication system, the transmitted signal sₖ(t) of Equation 1 can be expressed as Equation 6.

$${s}_{k} ( t ) = \sqrt{\frac{2 P}{{U}_{k}}} {\sum }_{l = 0}^{L - 1} {β}_{k , L - l - 1} {b}_{k} ( t - {lT}_{c} ) {a}_{k} ( t - {lT}_{c} ) exp ( \begin{matrix}jω ( t - {lT}_{c} ) - \\ {jγ}_{k , L - l - 1}\end{matrix} ) \qquad ( Equation 6 )$$

where P is the transmission signal power, ω is a carrier frequency, bₖ(t) is a data stream for the user k having the interval T modulated by the first modulator 110, the current bit is expressed as b⁰ₖ, the previous bit is given as b⁻¹ₖ, the next bit is denoted as b¹ₖ, aₖ(t) is a continuously orthogonal spreading code having an interval T_{c} and a code length N=T/T_{c}, and the waveforms of the bit and the chip are assumed to be square waves.

Uₖ is a normalizing factor, it maintains transmission power irrespective of the number of paths, and is expressed in Equation 7.

$${U}_{k} = {\sum }_{l = 0}^{L - 1} {β}_{k , l}^{2} \qquad ( Equation 7 )$$

A method for the receiver 200 to receive and process the transmitted signal will now be described.

In detail, the signal rᵢ(t) received from the receiver 200 of the terminal user i during a downlink time slot is expressed as Equation 8 according to the additive white Gaussian noise n(t) and the multipath channel 300.

$${r}_{i} ( t ) = n ( t ) + Re {\sum }_{k = 1}^{K} {\sum }_{j = 0}^{L - 1} {β}_{i , j} {s}_{k} ( t - j {T}_{c} ) exp ( {jγ}_{i , j} ) \qquad ( Equation 8 )$$

where n(t) is additive white Gaussian noise with a power spectrum density of N₀/2.

When Equation 6 is applied to Equation 8, channel outputs including 2L−1 paths are acquired, and the path corresponding to the central path of (j+1=L−1) has the peak value from among the 2L−1 paths.

Therefore, since the receiver 200 can receive and process the signal by using one matched filter for synchronization with the path of (j+1=L−1) corresponding to the peak, the receiver 200 has a simpler structure compared to the existing rake receiver that needs a matched filter for each path. In this instance, when i=1 is defined to be the user who is matched in the receiver 200, the output Z of the matched filter of the user 1 is expressed in Equation 9.

$$Z = {\int }_{( L - 1 ) {T}_{c}}^{( L - 1 ) {T}_{c} + T} {r}_{1} ( t ) {a}_{1} [ \begin{matrix}t - \\ ( L - 1 ) {T}_{c}\end{matrix} ] \cdot cos [ \begin{matrix}wt - \\ w {T}_{c} ( L - 1 )\end{matrix} ] d t \\ = D + S + A + η \qquad ( Equation 9 )$$

where η is a Gaussian random variable with a variance of N₀T/4, D is an item desired by the received signal, S is multipath interference, that is, self interference, and A is multiple access interference, that is, multi-user interference.

In detail, D is calculated for the current bit (b₁⁰) when k=1 and j+1=L−1 in Equation 8, and D is expressed in Equation 10.

$$D = \sqrt{\frac{P}{2}} {b}_{1}^{0} T \sqrt{{U}_{1}} \qquad ( Equation 10 )$$

Multipath interference S is expressed in Equation 11 when k=1 and j+1≠L−1 are applied to Equations 6, 8, and 9.

$$S = \sqrt{\frac{P}{2 {U}_{1}}} {\sum }_{j = 0}^{L - 1} {\sum }_{m = 0 , m \neq j}^{L - 1} {β}_{1 , j} {β}_{1 , m} cos [ \begin{matrix}{wT}_{c} ( j - m ) + \\ {γ}_{1 , m} - {γ}_{1 , j}\end{matrix} ] \cdot {\int }_{0}^{T} {b}_{1} [ t - ( j - m ) {T}_{c} ] {a}_{1} [ t - ( j - m ) {T}_{c} ] {a}_{1} ( t ) d t \qquad ( Equation 11 )$$

where ∫₀^{T}b₁(t−mT_{c})a₁(t−mT_{c})a₁(t)dt is expressed in Equation 12.

$${\int }_{0}^{T} {b}_{1} ( t - {mT}_{c} ) {a}_{1} ( t - {mT}_{c} ) {a}_{1} ( t ) d t = \{ \begin{matrix}{T}_{c} [ {b}_{1}^{- 1} {C}_{1 , 1} ( m - N ) + {b}_{1}^{0} {C}_{1 , 1} ( m ) ] & for m \geq 0 \\ {T}_{c} [ {b}_{1}^{0} {C}_{1 , 1} ( m ) + {b}_{1}^{1} {C}_{1 , 1} ( N + m ) ] & for m < 0\end{matrix} \qquad ( Equation 12 )$$

where C_{k,i}(m) is a discrete aperiodic cross-correlation function.

Also, Equation 13 can be obtained from Equations 11 and 12 when C_{i,i} is expressed as Cᵢ and the relation of Cᵢ(m)=Cᵢ(−m) is used.

$$S = \sqrt{\frac{P}{2 {U}_{1}}} {\sum }_{j = 0}^{L - 2} {\sum }_{m = j + 1}^{L - 1} {β}_{1 , j} {β}_{1 , m} cos [ \begin{matrix}{wT}_{c} ( j - m ) + \\ {γ}_{1 , m} + {γ}_{1 , j}\end{matrix} ] \cdot {T}_{c} \{ \begin{matrix}{b}_{1}^{- 1} {C}_{1} ( N - m + j ) + \\ {b}_{1}^{1} {C}_{1} ( N - m + j ) ] + 2 {b}_{1}^{0} {C}_{1} ( m - j )\end{matrix} \} \qquad ( Equation 13 )$$

In Equation 13, respective terms are uncorrelated since the average of each term is 0 for all j's and m's and their phase values are independent.

Therefore, the variance of S is expressed as Equation 14.

$$E [ {S}^{2} \vert \{ {β}_{1 , l} \} ] = \frac{{PT}_{c}^{2}}{2 {U}_{1}} {\sum }_{j = 0}^{L - 2} {\sum }_{m = j + 1}^{L - 1} {β}_{1 , j}^{2} {β}_{1 , m}^{2} [ \begin{matrix}{C}_{1}^{2} ( \begin{matrix}N - \\ m + j\end{matrix} ) + \\ 2 {C}_{1}^{2} ( m - j )\end{matrix} ] \qquad ( Equation 14 )$$

The multiple access interference A generated by the other user can be given by setting k>1 in Equations 6, 8, and 9, and is expressed in Equation 15.

$$A = \sqrt{\frac{P}{2}} {\sum }_{k = 2}^{K} {\sum }_{j = 0}^{L - 1} {\sum }_{m = 0}^{L - 1} \frac{{β}_{1 , j} {β}_{k , m}}{\sqrt{{U}_{k}}} cos [ \begin{matrix}ω {T}_{c} ( j - m ) + \\ {γ}_{k , m} - {γ}_{1 , j}\end{matrix} ] {\int }_{0}^{T} {b}_{k } [ t - ( j - m ) {T}_{c} ] {a}_{k} [ t - ( j - m ) {T}_{c} ] {a}_{1} ( t ) d t \qquad ( Equation 15 )$$

Equation 15 can be classified as two cases of m=j and m≠j as expressed in Equations 16 and 17.

$$A {\vert}_{m = j} = {T}_{c} \sqrt{\frac{P}{2}} {\sum }_{k = 2}^{K} {\sum }_{j = 0}^{L - 1} \frac{{β}_{1 , j} {β}_{k , j}}{\sqrt{{U}_{k}}} cos ( {γ}_{k , j} - {γ}_{1 , j} ) {b}_{k}^{0} {C}_{k , 1} ( 0 ) \qquad ( Equation 16 )$$

$$A {\vert}_{m \neq j} = \sqrt{\frac{P}{2}} {\sum }_{k = 2}^{K} {\sum }_{j = 0}^{L - 2} {\sum }_{m = j + 1}^{L - 1} \frac{{T}_{c}}{\sqrt{{U}_{k}}} \cdot \{ \begin{matrix}\begin{matrix}{β}_{1 , j} {β}_{k , m} cos [ \begin{matrix}ω {T}_{c} ( j - m ) + \\ {γ}_{k , m} - {γ}_{1 , j}\end{matrix} ] \cdot \\ [ \begin{matrix}{b}_{k}^{0} {C}_{k , 1} ( j - m ) + \\ {b}_{k}^{1} {C}_{k , 1} {C}_{k , 1} ( N + j - m )\end{matrix} ] +\end{matrix} \\ {β}_{1 , m} {β}_{k , j} cos [ \begin{matrix}ω {T}_{c} ( m - j ) + \\ {γ}_{k , j} - {γ}_{1 , m}\end{matrix} ] \cdot \\ [ \begin{matrix}{b}_{k}^{- 1} {C}_{k , 1} ( m - j - N ) + \\ {b}_{k}^{0} {C}_{k , 1} ( m - j )\end{matrix} ]\end{matrix} \} \qquad ( Equation 17 )$$

where, since all phases in the cosine (cos) function are independent, Equations 16 and 17 have averages of 0 and all the terms are uncorrelated.

Particularly, when a one-point orthogonal code such as the Walsh-Hadamard code is used, the entire period correlation C_{k,i} 0 of Equation 16 is 0.

Therefore, the variance of the multiple access interference A is expressed in Equation 18.

$$E [ {A}^{2} \vert \{ {β}_{1 , l} \} ] = \frac{{PT}_{c}^{2} Q}{4} {\sum }_{k = 2}^{K} \{ \begin{matrix}\begin{matrix}{WC}_{k , 1}^{2} ( 0 ) {\sum }_{m = 0}^{L - 1} {β}_{1 , m}^{2} {\sum }_{j = 0}^{L - 2} {\sum }_{m = j + 1}^{L - 1} {β}_{1 , j}^{2} \\ [ {C}_{k , 1}^{2} ( j - m ) + {C}_{k , 1}^{2} ( N + j - m ) ] \cdot \end{matrix} \\ {\sum }_{j = 0}^{L - 2} {\sum }_{m = j + 1}^{L - 1} {β}_{1 , m}^{2} [ \begin{matrix}{C}_{k , 1}^{2} ( m - j - N ) + \\ {C}_{k , 1}^{2} ( m - j )\end{matrix} ]\end{matrix} \} \qquad ( Equation 18 )$$

where a pointer factor W is introduced with W=0 (or equivalently C_{k,j}(0)=0) if orthogonal codes are used and W=1 otherwise, and Q is expressed in Equation 19.

$$Q = {Q}_{k , j} = E [ \frac{{β}_{k , j}^{2}}{{U}_{k}} ] = \frac{1}{L} , for j = 0 , 1 , … , L - 1 \qquad ( Equation 19 )$$

In this instance, it is given that Q_{k,0}+Q_{k,1}+ . . . +Q_{k,L-1}=1, which corresponds to the condition for maintaining the above-described transmission power.

Also, all C²_{k,1}(m)'s in Equations 14 and 18 can be expressed as expectations in Equation 20.

$$E [ {C}_{i}^{2} ( m ) ] = N - \vert m \vert for m \neq 0 \\ E [ {C}_{k , j}^{2} ( m ) ] = N - \vert m \vert \\ E [ {C}_{k , i} ( m ) {C}_{k , i} ( n ) ] = 0 for m \neq n , k \neq i \qquad ( Equation 20 )$$

A random spread code can be used so as to induce Equation 20 in the case of using a general one-point orthogonal code. However, as described above, the code used by the transmitter 100 is a continuously orthogonal spreading code such as a ZCD code and a ZCZ code, or a LAS code. In this case, Equation 21 is applied to the continuously orthogonal spreading region.

$$E [ {C}_{i}^{2} ( m ) ] = 0 for m \neq 0 \\ E [ {C}_{k , j}^{2} ( m ) ] = 0 \\ E [ {C}_{k , i} ( m ) {C}_{k , i} ( n ) ] = 0 for m \neq n , k \neq i \qquad ( Equation 21 )$$

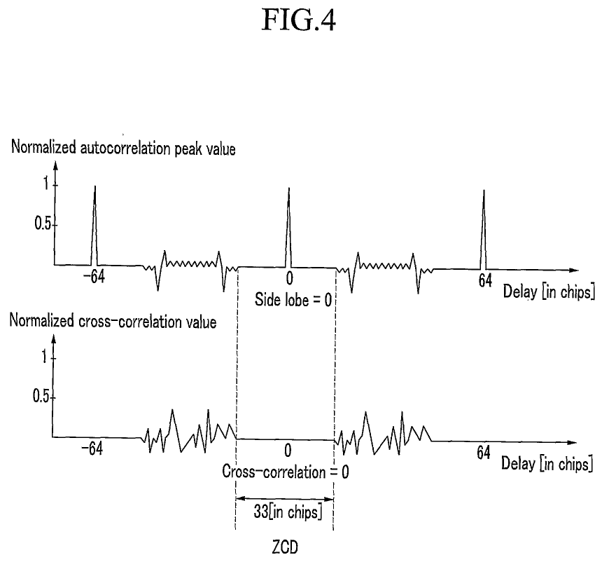

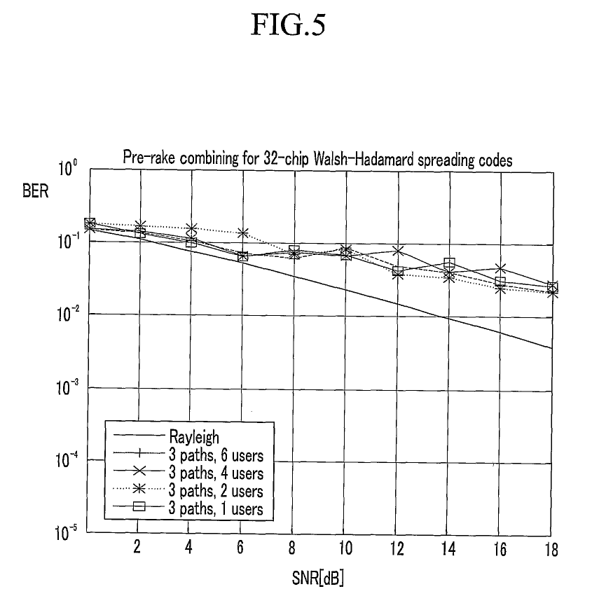

The BER characteristic for the case of using a continuously orthogonal spreading code in the transmitter 100 will be described with reference to FIG. 4 to FIG. 6. The ZCD spread code will be exemplified for the continuously orthogonal spreading code in FIG. 4 to FIG. 6, and other continuously orthogonal spreading codes are also applicable to the exemplary embodiment of the present invention.

FIG. 4 shows an autocorrelation characteristic and a cross-correlation characteristic of a binary ZCD spreading code.

Referring to FIG. 4, the correlation characteristic of the continuously orthogonal spreading code will now be described.

When two ZCD spreading codes S_{N}^{(x)}=(s₀^{(x)}, . . . ,s_{N-1}^{(x)}) and S_{N}^{(y)}=(s₀^{(y)}, . . . ,s_{N-1}^{(y)}) having the chip period of N are provided, the periodic correlation function and the aperiodic correlation function for the time shift (π) are respectively given as Equations 22 and 23.

$$\begin{matrix}Periodic {R}_{x , y} ( τ ) = {\sum }_{n = 0}^{N - 1} {s}_{n}^{( x )} {s}_{( n + τ , mod N )}^{( y )} & ( Equation 22 ) \\ Aperiodic {R}_{x , y} ( τ ) = {\sum }_{n = 0}^{N - τ - 1} {s}_{n}^{( x )} {s}_{( n + τ )}^{( y )} & ( Equation 23 )\end{matrix}$$

where sₙ^{(x)} and sₙ^{(y)} are respectively one chip of the spreading code. In this instance, the generation equations of the binary ZCD spreading code and the ternary ZCD spreading code having the continuously orthogonal characteristic can be expressed as Equations 24 and 25.

$$\begin{matrix}\{ \begin{matrix}\begin{matrix}{S}_{N}^{( a )} = ABA - BAB - ABABA - B - A - BA - B \\ {S}_{N}^{( b )} = CDC - DCD - CDCDC - D - C - DC - D\end{matrix} \\ where A = ( ++ + - ) , B = ( ++ - + ) , \\ C = ( + - ++ ) and D = ( + -- - )\end{matrix} \} & ( Equation 24 ) \\ \{ \begin{matrix}\begin{matrix}\begin{matrix}\begin{matrix}{S}_{N}^{( a )} = ABA - {BZ}_{i} AB - {ABZ}_{i} ABA - {BZ}_{i} - A - BA - {BZ}_{i} \\ {S}_{N}^{( b )} = CDC - {DZ}_{i} CD - {CDZ}_{i} CDC - {DZ}_{i} - C - DC - {DZ}_{i}\end{matrix} \\ where A = ( ++ + - ) , B = ( ++ - + ) , C = ( + - ++ )\end{matrix} \\ and D = ( + -- - ) ,\end{matrix} \\ {Z}_{i} = Inserted zeros\end{matrix} \} & ( Equation 25 )\end{matrix}$$

In Equations 24 and 25, N is the period of a spreading code, ‘+’ and ‘−’ are ‘+1’ and ‘−1’, A, B, C, and D are respectively a chip configuration formed by ‘+1’ and ‘−1’ in the spreading code, and Zᵢ is the number of 0's that are inserted into the tertiary ZDC spreading code.

The maximum ZCD interval of the binary ZCD spreading code generated from Equation 24 is 0.5N+1, and the maximum ZCD interval of the ternary ZCD spreading code generated from Equation 25 is 0.75N+1.

FIG. 4 shows the autocorrelation function and the cross-correlation function of the one pair of binary ZCD spreading codes having the period of 64 chips. In this instance, it is determined that the cross-correlation between the two codes is 0 in the interval that corresponds to (N/2+1) of the 64^{th} chip, that is, the 33^{rd} chip corresponding to (64/2+1). Also, the autocorrelation is 0 at the side lobe near the peak value of the autocorrelation in the above-noted interval.

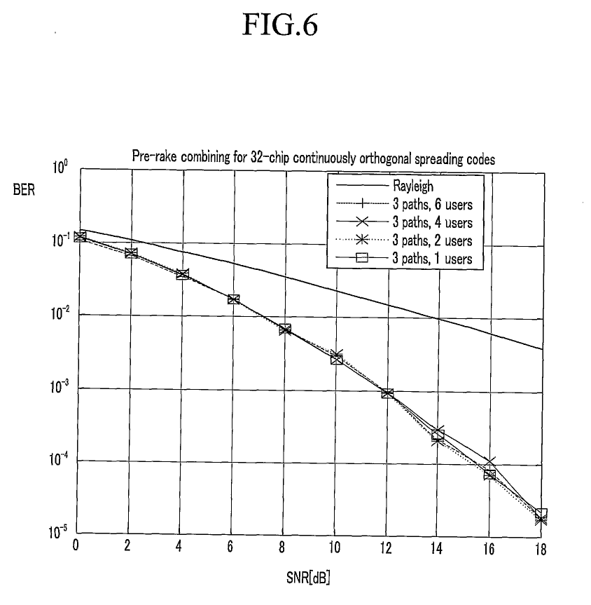

Referring to FIG. 5 and FIG. 6, the BER characteristics of the communication system according to the exemplary embodiment of the present invention will now be described.

Differing from the exemplary embodiment of the present invention, Equation 20 is applied to C²_{k,1}(m) in the communication system using the random spreading variable. Therefore, the BER characteristics are expressed as Equation 26 when Equation 20 is applied to Equations 14 and 18, the receiver output (Z) of Equation 9 is assumed to be a Gaussian random variable, and the BPSK modulation with the condition of {β_{1,n,}n=0,1, . . . , L−1} is performed by the first modulator.

P(e|{β_{1,n}})=0.5 erfc(\sqrt{Y}) (Equation 26)

where Y is the signal to interference plus noise ratio (SINR) including noise and interference, and is given as D²/2var(Z), and var(Z) is the variance of the Gaussian random variable (Z). Therefore, Y is expressed as Equation 27.

$$Y = {[ \frac{L}{\overline{{γ}_{b}} {U}_{1}} + \frac{4 χ}{{NU}_{1}^{2}} - \frac{2 μ}{{N}^{2} {U}_{1}^{2}} + \frac{( K - 1 ) ( L - 1 )}{NL} ]}^{- 1} \qquad ( Equation 27 )$$

where γ̅_̅{̅b̅}̅ is the average of the received signal-to-noise ratio (SNR), and χ and μ related to the multipath interference (S) can be expressed as Equation 28.

$$χ = {\sum }_{j = 0}^{L - 2} {\sum }_{m = j + 1}^{L - 1} {β}_{1 , j}^{2} {β}_{1 , m}^{2} \\ μ = {\sum }_{j = 0}^{L - 2} {\sum }_{m = j + 1}^{L - 1} ( m - j ) {β}_{1 , j}^{2} {β}_{1 , m}^{2} \qquad ( Equation 28 )$$

As can be known from Equation 28, interference is increased as the number of multipaths L and the number of users K increase, and the performance is deteriorated as the SINR Y is reduced in the communication system using the random spreading code.

However, when the spreading code having the continuously orthogonal characteristic is used according to the exemplary embodiment of the present invention, Equation 21 is applied to Equation 14 and Equation 18, and resultantly, interference components in Equation 27 become 0 and Equation 29 is acquired.

$$Y = {[ \frac{L}{\overline{{γ}_{b}} {U}_{1}} ]}^{- 1} \qquad ( Equation 29 )$$

That is, the multipath interference S and the multiple access interference A become 0, and influences caused by the interference are removed.

FIG. 5 and FIG. 6 are obtained when the BER performance is measured by using the parameters of Table 1 so as to check the performance of the communication system having combined the continuously orthogonal spreading code and the pre-rake combining method according to the exemplary embodiment of the present invention.

TABLE 1

| | |
|---|---|
| Wireless Access | CDMA/TDD |
| Scheme | |
| Time slot length | 0.667 ms |
| Spreading code | ZCD binary codes (PG = 32) |
| | Walsh Hadamard (PG = 32) |
| Transmit chip rate | 3.84 Mcps |
| Transmit data rate | 120 kbps |
| Uplink channel | Perfect |
| estimation | |
| No. of paths | 2, 3 Rayleigh fading (1 chip delay, |
| | equal path gain) |
| Modulation | BPSK |
| Max. Doppler frequency | 32 Hz |
| Channel | Uncoded |
| coding/decoding | |

FIG. 5 shows the BER performance of the CDM/CDMA wireless communication system in which the pre-rake method is applied to the Walsh-Hadamard spreading code with 32 chips in the Rayleigh fading condition having three paths and the multiple access condition. FIG. 6 shows the BER performance of the CDM/CDMA wireless communication system in which the pre-rake method is applied to the continuously orthogonal spreading code with 32 chips in the Rayleigh fading condition having three paths and the multiple access condition.

As shown in FIG. 5, when the pre-rake method is combined with the Walsh-Hadamard spreading code in the Rayleigh fading condition having three paths, the BER performance is gradually degraded as the number of users gradually increases, which indicates that the tolerance for the various temporal components such as the multipath fading interference or the multiple access interference caused on the transmission channel is degraded because of the Walsh-Hadamard correlation characteristics.

However, as shown in FIG. 6, the BER performance of the CDM/CDMA wireless communication system having combined the pre-rake method with the continuously orthogonal spreading code (binary ZCD spread code) having 32 chips in the Rayleigh fading condition having 3 paths and the multiple access condition according to the exemplary embodiment of the present invention can remove the influence of the interference component such as the multipath fading interference or multiple access interference because of the continuously orthogonal correlation characteristics for a predetermined time interval even when the number of users is increased, and the excellence of the BER performance is confirmed.

The CDM/CDMA system using TDD has been described in the exemplary embodiment of the present invention, and the embodiment thereof is also applicable to another TDD or frequency division duplex (FDD) system for feeding channel information provided by the terminal back to the base station.

According to the exemplary embodiment of the present invention, the pre-rake method is applied to the spreading code having the continuously orthogonal characteristic for a predetermined time interval so that a spread code that has 0 within a predetermined time is generated to thus remove interference without increasing system complexity.

The BER performance of the existing pre-rake system is degraded since the multipath fading interference and the multiple access interference are increased because of a plurality of multipaths compared to the general system using a rake receiver, and according to the exemplary embodiment of the present invention, the pre-rake method is applied to the spreading code having the continuously orthogonal characteristic for a predetermined time interval, and hence the BER is reduced and excellent low noise sensitivity is provided.

The above-described embodiment can be realized through a program for realizing functions corresponding to the configuration of the embodiment or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting a signal through a multipath channel in a communication system, comprising:
generating a continuously orthogonal spreading code for a user;
generating a spread signal by spreading-modulating a user signal by using the continuously orthogonal spreading code; and
performing a pre-rake combining on the spread signal and transmitting a pre-rake combined signal.

2. The method of claim 1, wherein performing the pre-rake combining comprises combining a channel impulse response for the multipath channel and the spread signal.

3. The method of claim 1, wherein the continuously orthogonal spreading code is continuously orthogonal for a predetermined time interval.

4. The method of claim 1, wherein the continuously orthogonal spreading code has an autocorrelation value and a cross-correlation value of 0 for a predetermined time interval.

5. The method of claim 1, wherein the continuously orthogonal spreading code includes one of a zero correlation duration (ZCD) code, a zero correlation zone (ZCZ) code, and a large area synchronous (LAS) code.

6. The method of claim 1, wherein the communication system is a code division multiplexing/code division multiple access (CDM/CDMA) system.

7. A method of receiving a signal through a multipath channel in a communication system, comprising:
receiving a pre-rake combined transmitted signal through the multipath channel; and
processing the received signal by using a matched filter for one path.

8. The method of claim 7, wherein the transmitted signal is generated by performing a pre-rake combining on a user signal spreading-modulated by a continuously orthogonal spreading code.

9. The method of claim 8, wherein a channel impulse response for the multipath channel is combined with the spreading-modulated user signal to perform the pre-rake combining.

10. The method of claim 8, wherein the continuously orthogonal spreading code is continuously orthogonal for a predetermined time interval.

11. The method of claim 8, wherein the continuously orthogonal spreading code has an autocorrelation value and a cross-correlation value of 0 for a predetermined time interval.

12. The method of claim 7, wherein the one path is a middle path among channel outputs including a plurality of paths.

13. The method of claim 7, wherein the communication system is a code division multiplexing/code division multiple access (CDM/CDMA) system.

14. A method of transmitting a signal through a multipath channel in a communication system, comprising:
spread-modulating a user signal by using a spreading code having a continuously orthogonal characteristic for a predetermined time interval;
combining a channel impulse response for the multipath channel with the spreading-modulated signal; and
transmitting the channel impulse response combined spread signal.

15. The method of claim 14, wherein the combining includes applying a complex conjugate of a reversed value of the channel impulse response to the spread signal.
